(19) United States
(12) Patent Application Publication
(10) Pub. No.: US 2014/0369158 A1
(43) Pub. Date: Dec. 18, 2014

(54) SYSTEM FOR EMPTYING A CONTAINER FILLED WITH FREE-FLOWING MEDIUM

(71) Applicant: Rainer Engenhart, Oak Ridge, NJ (US)

(72) Inventor: Rainer Engenhart, Oak Ridge, NJ (US)

(73) Assignee: Ekato Systems GmbH, Schopfheim (DE)

(21) Appl. No.: 14/112,688

(22) PCT Filed: Apr. 18, 2012
(86) PCT No.: PCT/EP2012/001678

§ 371 Date: Dec. 19, 2013

(30) Foreign Application Priority Data
Apr. 20, 2011 (DE) 10 2011 018 433.3

(51) Int. Cl. B01F 15/02

(52) U.S. Cl. CPC B01F 15/0292
USPC 366/192

(57) ABSTRACT

A system for emptying a container filled with free-flowing medium includes the following: a container (3) in which a product mass is homogenized by mixing; a discharge device (4) which is formed close to an inner wail of the container (3) and is introduced into the container (3) after the completion of the mixing, and a device (5) for applying pressure to the discharge device (4) in such a way that the discharge device presses the homogenized/mixed product mass downwards in the direction of the bottom of the container (3), where the homogenized/mixed product mass is discharged through an opened outlet valve of the container (3).

The invention relates to a system for emptying a container filled with free-flowing medium. In particular free-flowing medium is to be understood as a product which does no longer flow when subjected only to the gravitation force. The system of the present invention should be suitable in particular for use with such high-viscous media.

The production of viscous emulsions involves a homogenization of the product mass by mixing in a container. When the product mass has been very well homogenized in the container, a discharge of this product mass is performed. For various reasons, such as for example the shearing sensitivity, the product mass cannot be discharged by a pump.

Therefore, as indicated in the EP patent 0 515 852 A1, a system has been developed with a special mixing apparatus which is flange-mounted on a cover of the container, with which the product mass can be discharged gently and at a discharge rate of over 95%.

DE 352 172 A discloses an air-tightly closeable container for paints, dyes etc. and DE 362 557 discloses a syringe for medical purposes with a screw connection between the piston rod guide and glass cylinder.

DE 37 24 277 C2 discloses a device for mixing and/or drying of bulk material, wherein a lifting device is provided, with which a cover placed on it can be moved out.

The closest document DE 30 25 241 C2 discloses a system for emptying a container filled with a free-flowing medium, including the following: a container in which a homogenization of a product mass through mixing takes place; a discharge device which is configured close to an inner wall of the container and introduced into the container after completion of the mixing, and a device for applying pressure upon the discharge device, so that the homogenized/mixed product mass is pressed downwards and discharged through an outlet opening of the container. The discharge device is formed of flexible shape.

Against the background of this known prior art, the object of the invention is to still further increase the product yield for highly viscous media in batch processes.

This object is achieved in accordance with the invention by a system as set forth in patent claim 1. Patent claims 2 and 3 show advantageous refinements of the present invention.

The system according to the invention for emptying a container filled with free-flowing medium has in particular the following:
a container in which a homogenization of a product mass through mixing takes place;
a discharge device which is configured to extend close to an inner wall of the container and is introduced into the container after mixing has concluded; and
a device for applying pressure to the discharge device such that it pushes the homogenized/mixed product mass downwardly in the direction toward the bottom of the container for discharging the homogenized/mixed product mass through an open outlet valve of the container.

By configuring the discharge device in close proximity to the inner wall of the container in combination with the high viscosity/free-flowing properties of the homogenized/mixed product mass, it is possible to cleanly discharge the homogenized/mixed product mass also from the container wall. It allows not only a shear-free discharge with high product yield, but also “a pulse-free” discharge, which normally cannot be achieved with a pump (a positive displacement pump) designed for highly viscous media or products.

According to the invention, the system for emptying a container filled with a free-flowing medium has further a first cover mounted on a first lifting device and provided with a flange-mounted mixer for, with which a mixing for homogenization of the product mass is performed, with the first cover with flange-mounted mixer being completely mover away by f the first lifting device after the mixing.

According to the invention, the system for emptying a container filled with free-flowing medium has in addition as the device for applying pressure to the discharge device, a second cover which is pivotally mounted on a second lifting device with a pivoting capability so as to be able to move away from the container and toward the container, and which upon inserting the discharge device is pivoted toward the container and pressure-tightly closes the container, whereupon pressure is applied upon the discharge device in the container.

The discharge device is preferably a disk or a cylinder, which is made of pressure-resistant material with highest precision to closely proximate the inner diameter of the container and the inner wall of the container.

Advantageously, the disk or the cylinder may be placed as the discharge device upon the homogenized/mixed product mass.

Furthermore, the discharge device is preferably flexible in shape and conforms at the end of the discharge ideally to the bottom geometry of the container.

As a result of the shape-flexible construction of the discharge device, which is made for example of polyethylene (LDPE (low density polyethylene)), polytetrafluorethylene (PTFE) or similar material, a further residual reduction of homogenized/mixed product mass remaining in the container is realized.

The system according to the invention for emptying a container filled with free-flowing medium is capable to further increase the product yield in a simple manner compared with the discharge rate achieved with a system according to the prior art.

The above and further features and details of the invention are made clearer to an artisan in the art from the following detailed description and the accompanying drawings by way of an example, and wherein:

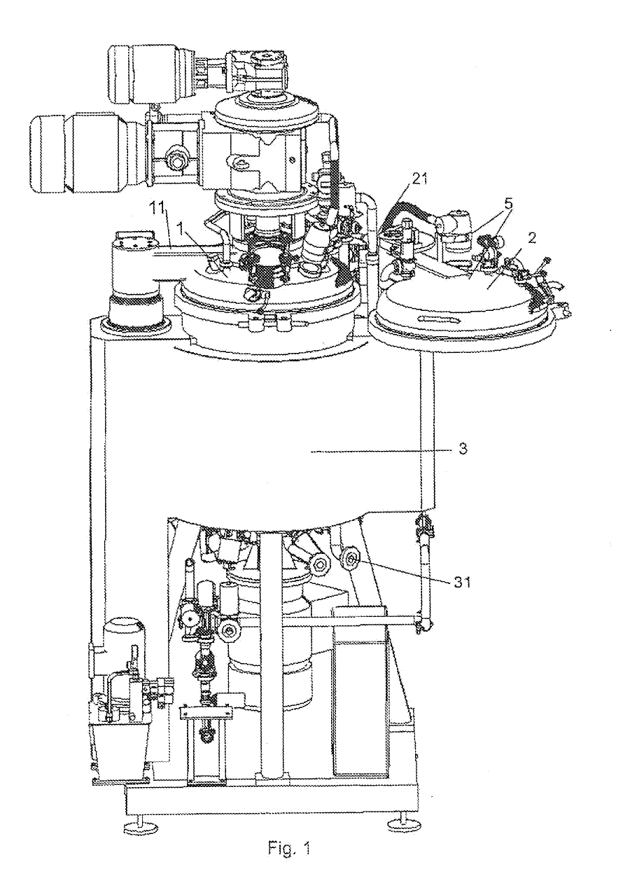

FIG. 1 shows a system according to the invention for emptying a container filled with free-flowing medium;

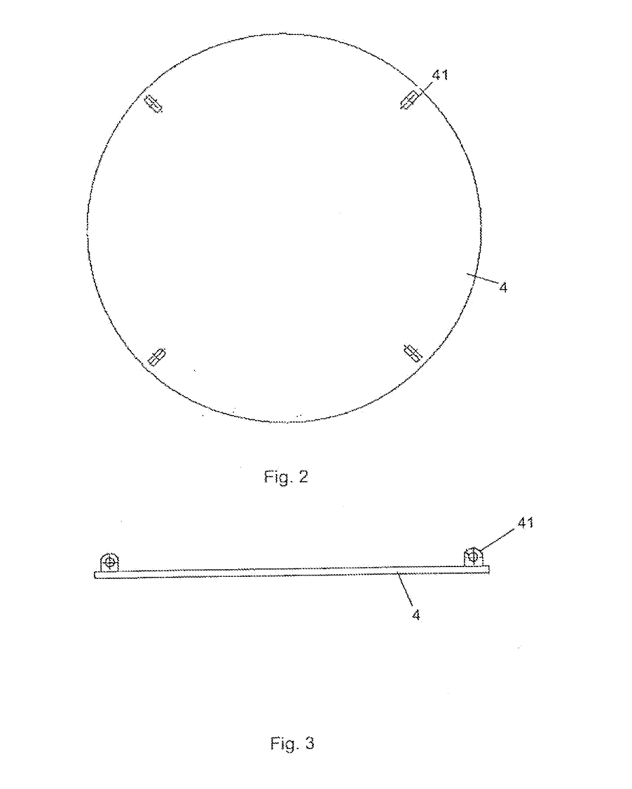

FIG. 2 shows a plan view of a discharge device according to the present invention; and

FIG. 3 shows a side view of a discharge device according to the present invention.

Hereinafter, the present invention is explained in detail by way of preferred embodiments with reference to the accompanying drawings.

FIG. 1 shows a system according to the invention for emptying a container filled with free-flowing medium. The system has a container 3 in which homogenization of high-viscosity/free flowing product mass takes place. The system is shown here in state of mixing, in which a first cover 1 closes the container. The first cover is supported on a first lifting device 11. A mixer is provided and flange-mounted on the first cover 1 for mixing to attain homogenization of the product mass. The first cover 1 with the flange-mounted mixer is fully moved away after the mixing by the first lifting device 11.

FIG. 1 further shows a second cover 2 which is pivotally mounted on a second lifting device 21 with a pivoting capability so as to be able to move away from the container 3 and toward the container 3, and which is rotated to the side away from the container 3 during mixing shown in FIG. 1.

Only after the first cover 1 with flange-mounted mixer has been fully moved away by the first lifting device 11 after mixing and has completely cleared the access to the container is, a discharge device 4 shown in FIGS. 2 and 3 is introduced into the container 3 and placed on the homogenized/mixed product mass. The discharge device 4 is configured to extend in close proximity to the inner wall of the container 3. It is preferably designed as a disk or a cylinder as shown in FIG. 2 by a plan view for the case of a cylindrical container 3 with a circular ring-shaped inner diameter. It is made of pressure-resistant material with highest precision to conform to the inner diameter of the container 3 and in close proximity to the inner wall of the container 3. The discharge device 4, as shown by the side view of FIG. 3, is moreover preferably shape-flexible and conforms ideally at the end of the discharge to the bottom geometry of the container 3. As a result of the shape-flexible configuration of the discharge device, which is preferably made of polyethylene (LOPE (low density polyethylene)), polytetrafluorethylene (PTFE) or similar materials, there is thus a further reduction of residual amounts of homogenized/mixed product mass remaining in the container.

After being placed in the container 3 and upon the homogenized/mixed product mass, a device 5 for pressure application applies pressure upon the discharge device 4 which thus pushes the homogenized/mixed product mass downwardly in a direction toward the bottom of the container 3, where the homogenized/mixed product mass is discharged through an open outlet valve 31 of the container 3.

For applying pressure upon the discharge device 4, provision is made for a second cover 2 which is shown in FIG. 1 and pivotally mounted on a second lifting device 21 with pivoting capability to move away from the container 3 and toward the container 3, and which after insertion of the discharge device 4 in the container 3 is pivoted toward the container 3 to pressure-tightly close the container 3, whereupon the discharge device 4 in the container is acted upon with pressure.

According to the invention, the first cover 1 with the flange-mounted mixer is removed from the container 3 after a mixing of the product mass. Thereafter, the discharge device 4, which is configured to closely proximate the inner wall of the container 3, is placed in the open and pressureless container 3 and on the product mass. Finally, pressure is applied upon the discharge device 4. For this purpose, the second cover 2 is for example pivoted in a direction towards the container opening to close the container. Then, the discharge device 4, which in particular is configured as disk or cylinder of pressure-resistant material, is acted upon with pressure and thereby pressed in a direction toward the bottom of the container 3. As a result, the product mass is discharged through an open outlet valve at the bottom of the container 3.

When the discharge device 4 has reached the bottom of the container 3 and the product mass has been discharged, pressure is relieved. In the described preferred embodiment of the present invention, a pressure relief of the container 3 is implemented and the second cover 2 is opened, so that the discharge device 4 can be removed from the container 3 (manually). This is preferably assisted by mounts 41 mounted onto the discharge device to facilitate the manual removal from the container 3.

The system according to the invention for emptying of a container filled with free-flowing medium attains a significantly improved product yield as compared to with known systems.

1.-3. (canceled)

4. A system for emptying a container, comprising:
a container having a bottom and filled with a product mass of free-flowing medium;
an outlet valve provided at the bottom of the container;
a first cover provided with a flange-mounted mixer for homogenization of the product mass and supported on a first lifting device for movement of the first cover away from the container and toward the container to allow mixing of the product mass, said first cover being moved away by the first lifting device after mixing of the product mass has completed;
a discharge device sized to extend close to an inner wall of the container and introduced into the container after completion of the mixing and movement of the first cover away from the container; and
a device for applying pressure upon the discharge device to push the product mass downwardly in a direction toward a bottom of the container for discharge of the product mass through the outlet valve, said device including a second lifting device and a second cover which is pivotally mounted on the second lifting device for movement between a first position in which the second cover is moved away from the container to a side while mixing of the product mass is carried out and a second position in which the second cover, after insertion of the discharge device into the container, is moved toward the container, to pressure-tightly close the container and allow pressure to be applied upon the discharge device in the container.

5. The system of claim 4, wherein the discharge device is a disk or a cylinder, which is made of pressure-resistant material and configured to conform to an inner diameter of the container and in close proximity to the inner wail of the container.

6. The system of claim 4, wherein the discharge device is shape-flexible and conforms to a bottom geometry of the container when the product mass has been discharged through the outlet valve.
